(19) United States
(12) Patent Application Publication
(10) Pub. No.: US 2017/0036343 A1
(43) Pub. Date: Feb. 9, 2017

(54) HANDLING DEVICE AND HANDLING METHOD

(71) Applicant: KUKA SYSTEMS GMBH, Augsburg (DE)

(72) Inventor: Thomas Sturm, Wiedenzhausen (DE)

(21) Appl. No.: 15/302,706

(22) PCT Filed: Apr. 2, 2015
(86) PCT No.: PCT/EP2015/057353

§ 371 Date: Oct. 7, 2016

(30) Foreign Application Priority Data
Apr. 9, 2014 (DE) 20 2014 101 663.5

(51) Int. Cl. B25J 9/00; B25J 11/00; B25J 5/00

(52) U.S. Cl. CPC B25J 9/009; B25J 5/007; B25J 11/0075; Y10S 901/01

(57) ABSTRACT

A manipulation device (2) and a manipulation method are provided for a processing tool (3). The manipulation device (2) has two cooperating manipulation units (8, 9) which together hold a support (16) and guide the support with coordinated movements. The processing tool (3) is provided on the support (16) such that the processing tool (3) can be moved by a conveying device (18).

### CROSS REFERENCE TO RELATED APPLICATIONS

This application is a United States National Phase Application of International Application PCT/EP2015/057353 filed Apr. 2, 2015, and claims the benefit of priority under 35 U.S.C. §119 of German Application 20 2014 101 663.5 filed Apr. 9, 2014, the entire contents of which are incorporated herein by reference.

### FIELD OF THE INVENTION

The present invention pertains to a handling device and to a handling method for a processing tool with plurality of, especially two cooperating handling units, which together hold a support and guide same with coordinated movements.

### BACKGROUND OF THE INVENTION

Large-format objects, e.g., aircraft, buses, railroad cars, etc., are painted in practice manually. There also are efforts for automation with handling devices, which guide a painting tool and which are arranged on stationary portal-like frames.

### SUMMARY OF THE INVENTION

An object of the present invention is to provide an improved handling technology for a processing tool.

According to the invention, the handling is for handling a processing tool. The handling device comprises a plurality handling units, which together hold a support and guide same with coordinated movements. The processing tool is arranged movably at the support. The support has a conveying device for the processing tool.

The handling device is capable of positioning and moving one or more processing tools for the many different processes at a process site, especially at a workpiece. The workpieces and the processes may have any desired nature. There are special advantages in case of application processes, especially painting processes. The application can be carried out with high precision and in a strip-like manner. The handling device is especially suitable for large-format workpieces or objects, especially aircraft, buses and railroad cars.

The handling technology is highly flexible and can be adapted to a great variety of workpieces or objects. The handling device is, in addition, mobile and can move along the workpiece or object or be positioned at different sites. The handling device can, in addition, be conveyed to different sites of use and built up there and adapted to the particular intended use with relatively little effort. There are special advantages for a so-called paint shop, which may be mobile and with which aircraft can be repainted worldwide as needed. The handling technology may also be used in the manufacture of aircraft or other workpieces or objects.

The handling device being claimed has a plurality of, especially two cooperating handling units, which together hold a support and guide same with coordinated movements, the processing tool being arranged movably at the support. The support preferably has a conveying device for the processing tool. The processing tool can be moved, preferably displaced, as a result along the support. The driving energy for the movement may originate from a controllable drive or its own or from the force of gravity and a slope of the support brought about by one of the handling units. The handling units hold the support preferably at the end areas thereof, especially at mutually opposite front ends. The connection between the respective handling unit and the support may be separable by means of a coupling. A connection with a joint, especially with a universal joint, may be present for a movable connection between the handling unit and the support.

For a constraint-free conveying of the support, the handling unit may have a compensating device. This may offer an additionally, especially translatory degree of freedom. It may be configured, e.g., as a rotatable and displaceable connection to the support or as an intermediate link.

In a preferred embodiment, the connection between a handling unit and the support has a supporting spider, on which the support is mounted rotatably. A sliding bearing may additionally be present for purposes of compensation. The number and orientation of the supporting spider arms, e.g., two, three, four or more, determines the preset possible rotation positions. The respective rotation position can be fixed by means of a controllable locking mechanism. The supporting spider may, in turn, be connected to a handling unit via a joint, especially a universal joint, directly or optionally indirectly via an interconnected bracket.

The handling technology can be adapted rapidly and in a simple manner to different sizes and types of workpieces or objects, especially to any desired aircraft. Different supports may be used here, which have, e.g., different lengths or different shapes. The support may also be separated from the handling devices and deposited on the outside, so that the handling devices can move independently from one another and independently perform other applications or processes. It is favorable for this if the handling units equipped with a multiaxial and programmable industrial robot also have replaceable tools along with a change coupling and tool storage sites. The handling units may, in addition, be equipped with a supply unit, which is carried along and supplies both the handling unit itself and the support and one or more processing tools along with a conveying means for moving the tool at the support.

The handling devices are movable and may contain a conveying means, which is preferably configured as an omnidirectional conveying device. The conveying means may be uncoupled as needed, so that a plurality of handling devices or handling units may share a common conveying means. This substantially reduces the design effort and the cost. A conveying means that can be used for a plurality of purposes is also favorable for reducing the amount of devices needed and simplifies the conveying and the transfer of the handling device to different sites of use, especially to different airports in different countries. The conveying means capable of being uncoupled may, in addition, also be used for other additional purposes.

The handling device may have a detection device for process specifications, especially for the position in space of the support and/or of the processing tool. This makes it possible to continuously monitor the position and the process, and the workpiece or the object can also be integrated in the detection and monitoring. Any desired elasticity, e.g., bending of the support, can be compensated by means of the handling units within the entire system and optimal, reproducible process conditions can be created.

The handling technology being claimed has, furthermore, the advantage that the stability of the system and the quality of the process are very high in all positions that can be reached with the processing tool. Tried and tested mechanical standard assembly units can be used for the handling device. The quality of the process can also be monitored as well as logged and demonstrated for purposes of quality assurance.

The handling technology being claimed may be part of a processing device or processing technology. These may have a plurality of handling devices, with which a plurality of identical or different processes can be carried out simultaneously in different areas of the workpiece or on different workpieces.

A partial aspect according to the present invention of the handling technology being claimed is the configuration and design thereof in the manufacture or first processing of workpieces in the field of aerospace, especially in aircraft or other flying objects. This applies especially to the painting of aircraft or other flying objects.

Another partial aspect according to the present invention of the handling technology being claimed is the configuration and use thereof in the finishing or retrofitting of workpieces in the field of aerospace, especially in aircraft or other flying objects. This may pertain to a painting process on aircraft or other flying objects, especially within the framework of a so-called paint shop.

Another partial aspect according to the present invention of the handling technology being claimed is the configuration and use thereof in any technical areas with the exception of the field of aerospace. These areas are called non-aerospace areas. Any desired processes can be carried out here with the handling technology being claimed. This pertains, in particular, to the processing, manufacture or outfitting of any desired workpieces or objects in the non-aerospace area. Such non-aerospace areas may be, e.g., means of transport, especially land vehicles or watercraft, e.g., road or rail-borne vehicles or ships. The non-aerospace areas also include rotor wings of wind mills, turbine or blower blades or the like. In addition, immobile objects, e.g., buildings or other real estate, may also belong to the non-aerospace areas. This may pertain, e.g., to wind-exposed walls or facades, especially of high-rise buildings.

The present invention is described in detail below with reference to the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view showing a handling device for a processing tool in one of different processing positions at a workpiece;

FIG. 2 is a schematic view showing a handling device for a processing tool in another of different processing positions at a workpiece;

FIG. 3 is a schematic view showing a processing device with a plurality of handling devices in one of different positions at an aircraft;

FIG. 4 is a schematic view showing a processing device with a plurality of handling devices in another of different positions at an aircraft;

FIG. 5 is a schematic view showing a processing device with a plurality of handling devices in another of different positions at an aircraft;

FIG. 6 is a schematic view showing a handling device with two handling units and with a support during conveying;

FIG. 7 is a schematic view showing one of different possibilities of connecting an industrial robot of a handling unit at a support with a compensating device;

FIG. 8 is a schematic view showing another of different possibilities of connecting an industrial robot of a handling unit at a support with a compensating device;

FIG. 9 is a schematic view showing a variant of a compensating device with arrangement at an industrial robot and at a storage site for the support;

FIG. 10 is another schematic view showing a variant of a compensating device with arrangement at an industrial robot and at a storage site for the support;

FIG. 11 is a schematic view showing one of different possibilities of associating a processing tool with a handling unit;

FIG. 12 is another schematic view showing another of different possibilities of associating a processing tool with a handling unit;

FIG. 13 is another schematic view showing another of different possibilities of associating a processing tool with a handling unit;

FIG. 14 is another schematic view showing another of different possibilities of associating a processing tool with a handling unit;

FIG. 15 is a schematic perspective view of a handling device;

FIG. 16 is a schematic view showing a detail view of a support, of an industrial robot and of a processing tool;

FIG. 17 is a schematic view showing a variant of the compensating device in one of different views;

FIG. 18 is a schematic view showing a variant of the compensating device in another of different views; and

FIG. 19 is a schematic view showing a variant of the compensating device in another of different views.

### DESCRIPTION OF THE PREFERRED EMBODIMENTS

Referring to the drawings, the present invention pertains to a handling device (2) and to a handling method. The present invention pertains, further, to a processing device (1) with one or more handling devices (2) as well as to a corresponding method.

The handling device (2) is used to handle, especially to position and move, a processing tool (3) relative to a workpiece or object (4). The handling device (2) has a plurality of handling units (8, 9) and one or more supports (16).

The handling device (2) may have, furthermore, a detection device (7) for process specifications. The detection device (7) may be a multipart device and/or have a plurality of detection functions. It may also be present as a plurality of devices. It may also be part of the processing device (1).

The processing tool (3) may carry out any desired processes and may have any desired configuration. In the exemplary embodiments shown and described, this is an application process for a fluid medium, especially for a paint, wherein the processing tool (3) is configured as an application tool. The application tool (3) may be used, e.g., not only to apply the fluid medium to the surface of the workpiece but also to emboss it and to profile it on the surface as well as to stabilize it, especially to strengthen and cure it during the application. The profiling on the surface of the medium or paint may have a microstructure with elevations and depressions, which are oriented, e.g., in a profiled manner along the main axis or the direction of motion of an aircraft or other means of transport or workpiece (4) configured as a rotor wing. Such a microstructure is also called riblet and is used to affect the air resistance during flight and to reduce fuel consumption. Such an application tool (3) may be configured, e.g., according to DE 10 2006 004 644 A1. The efficiency of conversion of the kinetic energy into electric, mechanical or other energy can be increased in a rotor wing, e.g., of a wind mill.

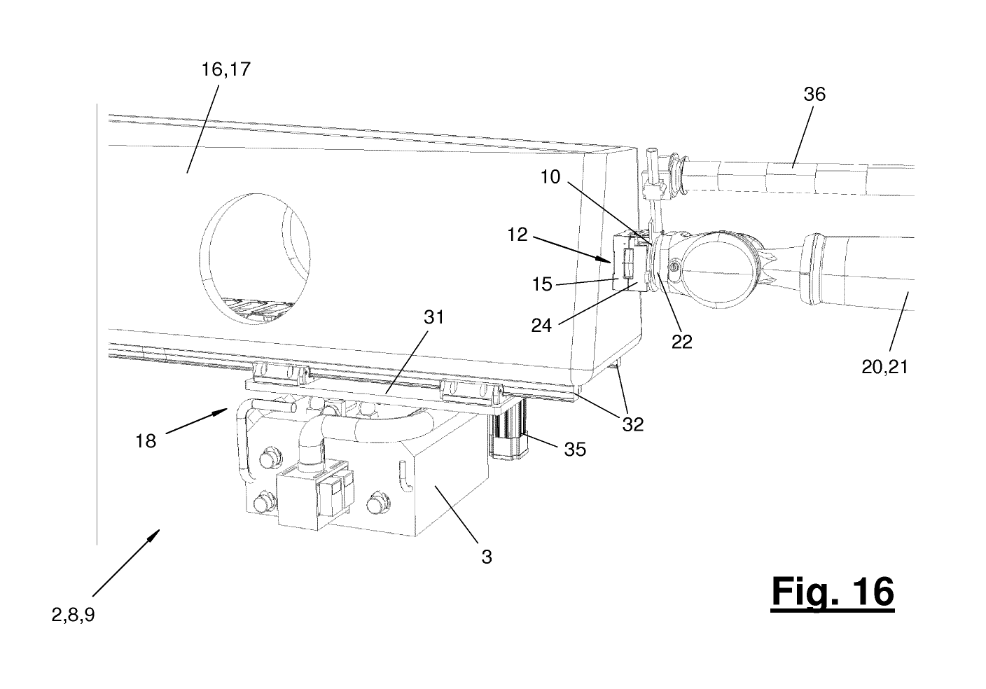

In another embodiment, which is shown in FIG. 16, the application tool (3) may have a rotatably mounted, hollow and dimensionally stable cylindrical or tubular supporting body, which is enclosed from the outside by a compressed air pad in a sealing cover, wherein an endless, ring-shaped die with an embossing profile on the outside is arranged on the compressed air pad, wherein the fluid medium to be applied is conveyed with said profile to the application site on the workpiece surface, is applied there and is at the same time mechanically profiled with the embossing profile under a pressing pressure and is strengthened by means of a stabilizing device, which is carried along. The stabilizing device may be, e.g., a light source, which is arranged in the supporting body and emits UV light for curing through the correspondingly transparent parts of the supporting body, of the pressing pad and of the die to the application and pressing site. The supporting body with the pressure pad and die is pressed onto the application site on the surface of the workpiece and is moved relative to the surface of the workpiece, the die and the cover of the pressure pad being flexurally elastic, roll rotatingly and undergo deformation while forming the pressing surface and becoming adapted to the surface contour of the workpiece in the process. The die may additionally be driven rotatingly at the application tool (3) by a separate drive, which may take place directly or indirectly via the pressure pad provided with inner overpressure.

Other possible processes pertain to an inspection, assembly, handling of components, mechanical or other processing of the workpiece surface, especially by machining by grinding, milling or the like. Further, a process may consist of an activation or an electrical charging of the workpiece surface or of the workpiece (4). In addition, any other desired processes, e.g., assembly processes with welding, soldering, bonding or the like, are possible. The processing tool (3) is configured correspondingly in adaptation to the aforementioned processes.

In another variant, not shown, the processing tool (3) may be configured as a small robot, which has one or more robot links and robot axes and carries a tool element for carrying out any desired process. Such a small robot of a lightweight construction is especially suitable for handling and assembly tasks. It may also have an integrated sensor mechanism detecting external loads and a programmable robot control.

The handling device (2) may have one or more and optionally replaceable processing tools (3). An individual processing tool (3) or even a plurality of identical or different processing tools (3) may be used here at the same time. Further, a tool magazine may be present.

The workpiece (4) or object may have any desired configuration. It may be stationary or nonstationary. In the exemplary embodiments shown, the workpiece (4) is configured as an aircraft, which has a fuselage (5) and wings (6). In another embodiment, the workpiece (4) may be another, likewise large-format means of transport, e.g., a bus, a truck or a trailer, a railroad car or the like. The workpiece (4) may also have a smaller format. Further, the workpiece (4) may be a building or another stationary object.

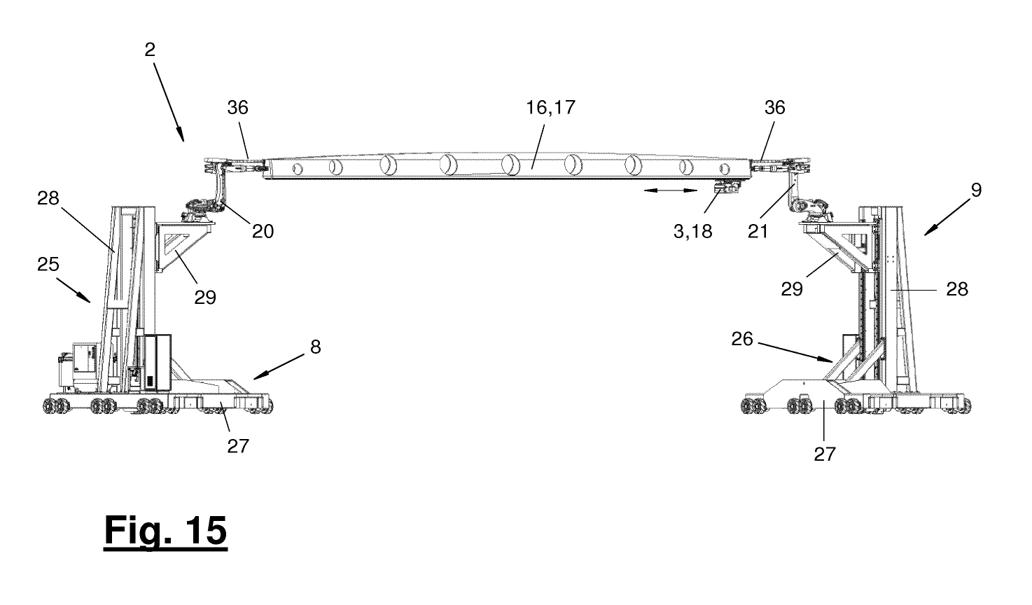

The handling device (2) has a plurality of handling units (8, 9), which together hold a support (16) and guide same with coordinated movements in the process. The processing tool (3) is arranged movably on the support (16). In the preferred exemplary embodiments shown, there are two handling units (8, 9), which may have identical or similar configuration. They are arranged at spaced locations from one another and hold the support (16) at different points, especially at edge or end areas thereof. The support (16) is configured as a supporting beam (17) in the exemplary embodiments shown. FIG. 15 shows a design embodiment of such a handling device (2).

In a variation of the exemplary embodiments shown, the number of handling units (8, 9) may be greater than two and may equal, e.g., three, four or more. Further, the support (16) may have another shape and may have, e.g., a plate-like or frame-like configuration, wherein three or more handling units (8, 9) act on different edge areas of the support (16).

The processing tool (3) may be arranged at the support (16) movably in any desired manner. A conveying device (18) is preferably provided herefor. Two or more processing tools (3), for which a common conveying device (18) or different separate conveying devices may be provided, may be arranged at a support (16). In the exemplary embodiments shown and described, the processing tools (3) move along a predefined path at the support (16) and carry out a strip-related process. This is the strip-like application of a medium in the case of the preferred application tools (3).

The support (16), especially the supporting beam (17) shown in the exemplary embodiments, is manufactured from a lightweight material. This may consist of, e.g., carbon fibers with a corresponding binder. The supporting beam (17) preferably extends straight or optionally with a slight bend. It may also be adapted to the optionally arched surface contour of the workpiece (4).

The supporting beam (17) is configured as a hollow box or frame construction in a flexurally rigid construction with corresponding reinforcements. In its hollow interior space, it may accommodate supply lines for operating materials, especially energy, fluid media, electric power and signal currents or the like.

The support (16) has said conveying device (18) for one or more processing tools (3). The conveying device (18) may have various configurations. It has, e.g., a conveying means (31) movable in a controlled manner along the support (16) with a guide (32). The conveying means (31) may be configured, e.g., as a carriage, which is moved along on a rail guide (32). In a supporting barn (17), this may be a straight or optionally bent guide (32). FIG. 16 illustrates a detail of this arrangement.

As an alternative, a plurality of guides (32) may be present on a support (16) or supporting beam (17) for a plurality of separately movable conveying means (31). The plurality of guides (32) may be arranged in parallel or obliquely or at right angles to one another. In another variant, a plurality of conveying means (31) may optionally be moved independently from one another on a guide (32).

The conveying mans (18) has a controllable drive (35) for the conveying means (31) in the exemplary embodiments shown. The detection device (7) may also have a suitable sensor mechanism for detecting the current travel position of the conveying means (31) at the support (16) in this case. The detection device (7) may have, further, a sensor mechanism for detecting external loads, especially forces and/or torques, which occur during the process. This may be, e.g., the pressing force of an application tool (3) on the workpiece (4).

The controllable drive (35) is connected to said control, especially robot control. It may have any desired and suitable configuration. In the exemplary embodiment shown, it is configured as a belt or toothed rack drive and has an electric drive motor with a driven element, especially with a pinion, and with driving means meshing with same, e.g., with an endless belt or with a toothed rack.

In another embodiment, not shown, a separate, controllable drive (35) for the conveying means (31) may be eliminated or switched off. The conveying means (31) is moved in this case controlled by the force of gravity and by a slope of the support (16), which is set by the handling units (8, 9). The conveying means (31) may now have a braking device and optionally a fixing mechanism at the desired end position at the support (16). Such an arrangement may be advantageous, e.g., in conjunction with a processing tool (3) configured as a small robot.

The conveying means (31) has a connection (34) for the processing tool (3). A fixed or detachable connection can be established via this connection. The connection (34) may be configured, e.g., as a change coupling. It may also be configured as a media coupling, in which case said one or more operating means is/are transmitted from the support (16) to the processing tool (3).

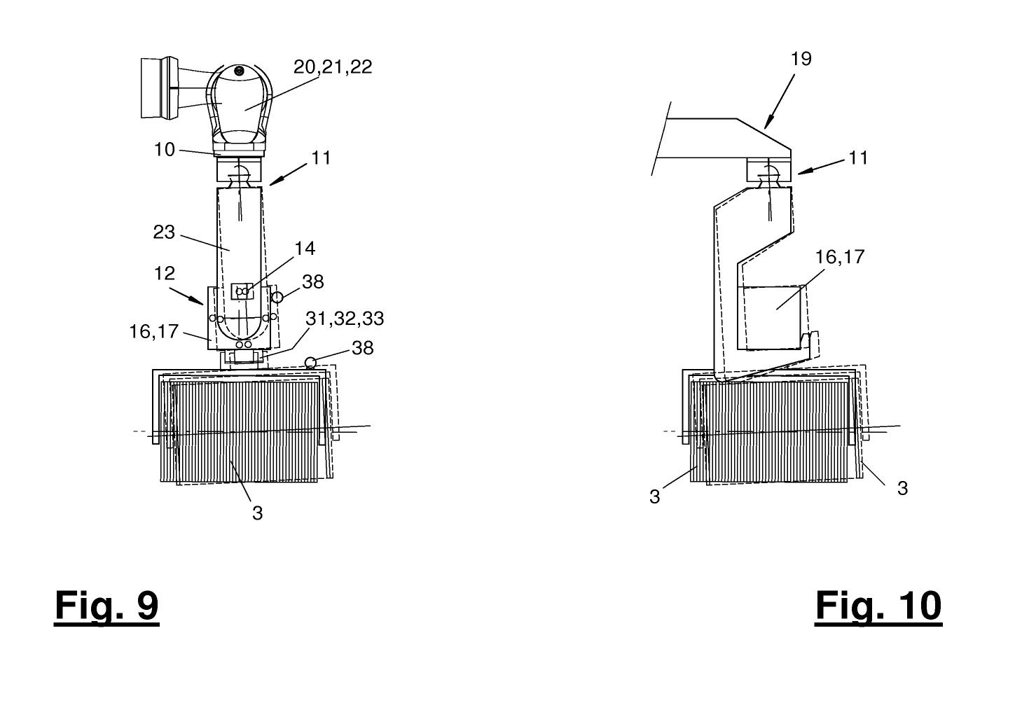

The connection of the processing tool (3) with the conveying means (31) may be rigid or movable. An adjusting device (33) with one or more adjustment axes may be arranged at the connection site, especially at the connection (34). This may be, e.g., a rotating device indicated in FIG. 9.

A connection (12) is arranged at the connection sites between the handling units (8, 9) and the support (16), especially at the supporting beam (17). In the exemplary embodiments shown, two handling units (8, 9) hold the supporting beam (17) at its front-side end areas by means of connections (12). One or more handling units (8, 9) have here a coupling (10) for detachable connection to the support (16) or to the connection (2). This may be an automatic change coupling. In addition, said operating materials may be transferred via the coupling (10) from a handling unit (8, 9) to the support (16).

The handling units (8, 9) may carry along, further, a supply device (30) for said operating materials. The supply device (30) may have, e.g., an energy supply, a media supply for the paint or the like, for compressed air, suction air, hydraulic fluid or other operating media, etc. It may also contain additional process equipment. Further, each handling unit (8, 9) may have a programmable control (not shown). One handling unit (8) may be configured and controlled in the cooperating handling units (8, 9) as a master and the other handling unit(s) (9) as a slave.

The handling devices (8, 9) shown in the exemplary embodiments preferably have an identical configuration. They have a multiaxial, programmable industrial robot (20, 21) each with a driven link (22). The industrial robot (20, 21) may have a plurality of robot links and a plurality of driven robot axes. It may have any desired number and combination of rotatory and/or translatory robot axes. In the exemplary embodiments shown, the industrial robot (20, 21) is configured as an articulated arm robot or bent-arm robot and has five or more robot axes. It has, in addition, a robot control (not shown). The driven link (22) is configured, e.g., as a driven flange and carries out a rotary driven motion.

At least one handling unit and preferably all handling units (8, 9) has/have a movable supporting device (25, 26) for one or more industrial robots (20, 21). The supporting device (25, 26) is displaceable in different directions on the foundation, here the shop floor. It has a support frame (28) with a conveying means (27). In individual cases, a supporting device may have a stationary configuration.

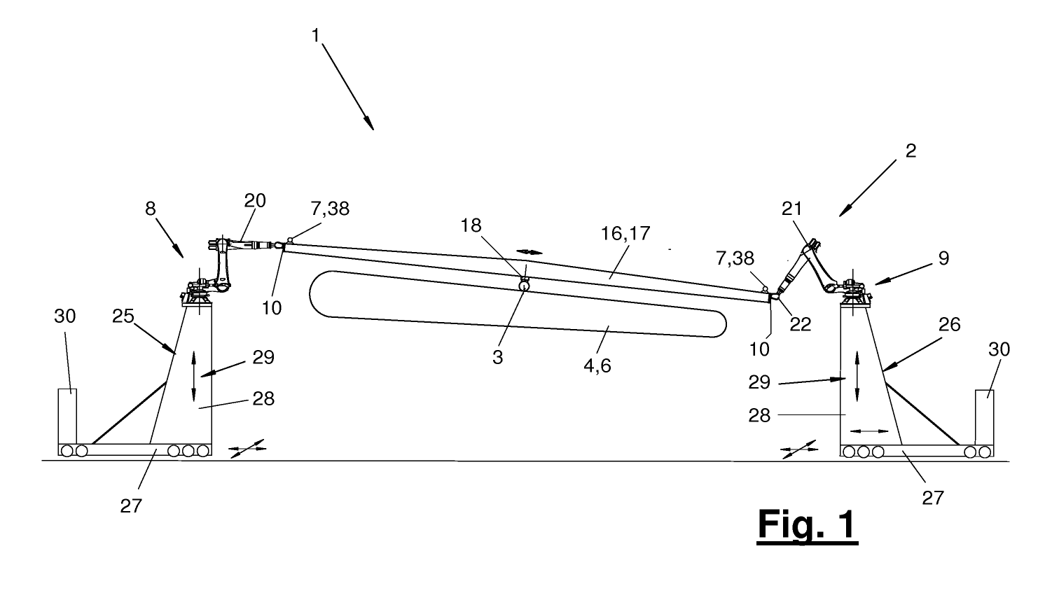

The support frame (28) may have a rigid configuration. In the exemplary embodiments shown, it has a moving device (29) for moving the industrial robot (20, 21). In the schematic view shown in FIG. 1, it is symbolized by arrows. FIG. 15 shows a design embodiment. The moving device (29) may have one or more motion axes and is connected to said control, especially robot control. The moving device (29) may be especially a lifting platform, with which the industrial robot (20, 21) can be adjusted vertically relative to the foundation. In addition, a motion axis directed at right angles thereto, e.g., a cross slide or the like, may also be present.

The conveying means (27) may have any desired and suitable configuration. In the exemplary embodiments shown, it is configured as an omnidirectionally movable conveying device, which is preferably floor-mounted. Such a conveying device may be configured corresponding to EP 2 137 053 B1 and have a plurality of Mecanum wheels. It may be steerable and moved by remote control. As an alternative, it can independently travel over a preprogrammed travel path and detect the current area in which it travels for control purposes as well as for avoiding collision.

The conveying device (27) is preferably arranged on the underside of the support frame (28). It may be permanently or detachably connected to the support frame (28). The support frame (28) may be supported at the site of use on the conveying means (27) or with possibly extensible feet of its own on the foundation. The latter also happens when the conveying means (27) is uncoupled and moved away.

The driven link (22) of the industrial robot (20, 21) may be connected to the connection (12) of a support (16) or supporting beam (17) in different ways. This may be carried out directly or through the intermediary of an extension arm (23). A coupling (10), e.g., an automatic change and media coupling, may optionally also be arranged at the driven link (22). FIG. 16 shows, furthermore, a media feed (36), which is arranged at the industrial robot (20, 21), is connected to the media coupling (10) and optionally establishes a connection to the supply device (30) at the support frame (28).

The industrial robot (20, 21) may also let the support (16) go and deposit it at a suitable location, e.g., at a storage site (19) that is carried along. It can then grip another tool by means of the change coupling (10) and perform another process. The handling units (8, 9) can now operate and carry out different processes independently from one another. The handling units (8, 9) may also have for this purpose a tool storage site or a magazine for a plurality of tools, which is arranged, e.g., at the support frame (28).

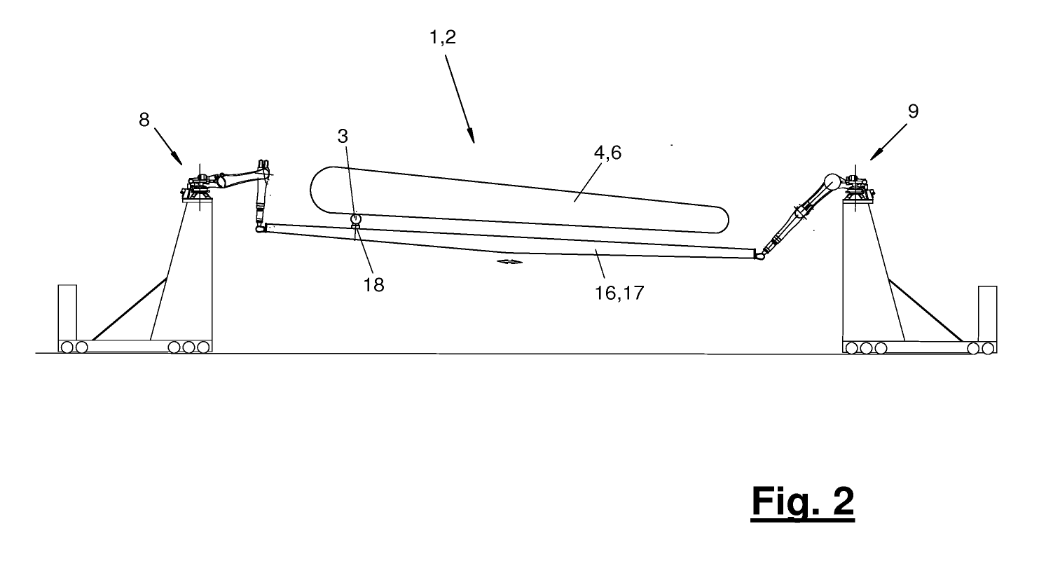

As is illustrated by FIGS. 1 and 2 in a schematic view, a process can be carried out with a handling device (2) on different sides of a workpiece (4). The support (16) and the processing tool (3) are arranged in FIG. 1 above the workpiece (4), here an aircraft wing (6), and carry out the process on the top side thereof. This may be, e.g., said application process, in which case the fluid medium, especially the paint, is applied in a plurality of parallel and mutually adjoining paths. Said wing surface and optionally also the edge area of said wing surface can be coated, especially painted, with the medium as a result.

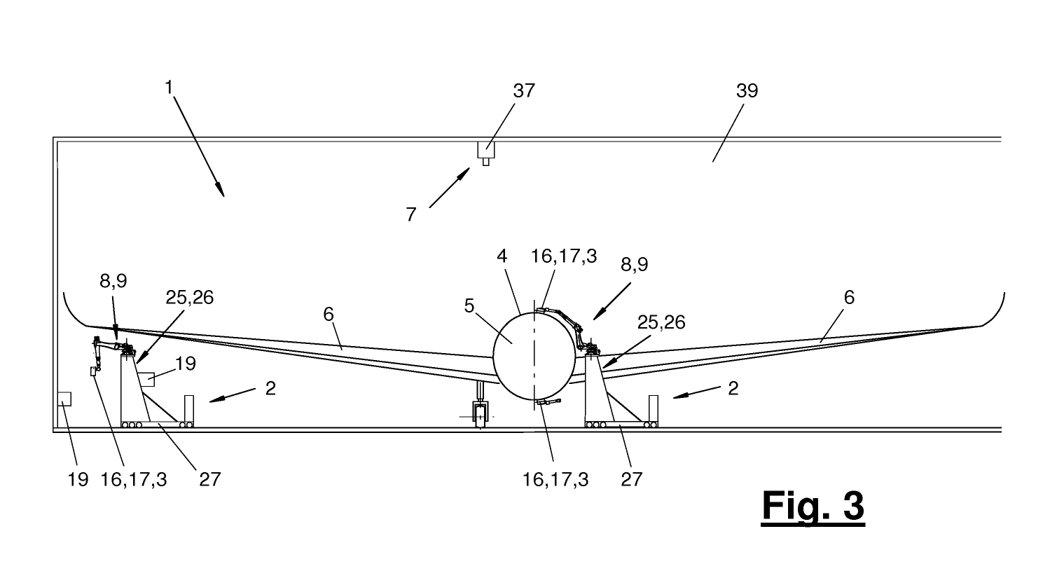

In the variant shown in FIG. 2, a process can be carried out with the same handling device (2) on the underside of the workpiece (4) or wing (6). The support (16) and the processing tool (3) are arranged and held here under the wing 6) as well as in the reversed position. FIGS. 3 through 5 show other possibilities of use, and a processing device (1), especially an application device, which comprises a plurality of handling devices (2), is shown here as well.

For example, a handling device (2) is performing a process on the top side of the fuselage (5) of an aircraft (4) in FIG. 3. The support (16) and the handling units (8, 9) are aligned and arranged here along the workpiece (4) or fuselage. In addition, FIG. 3 shows a support (6) with a processing tool (3) on the underside of the fuselage (5) in a cut-away view.

While one handling device (2) is carrying out a process, another handling device (2), shown in the left-hand part of FIG. 3, can carry out another process. A support (16) or supporting beam (17) with the processing tool (3) may optionally also be able to be changed in the handling devices (2). For example, supports (16) or supporting beams (17) of different lengths may be used for different process or workpiece areas.

To receive one or more supports (16) or supporting beams (17), a storage site (19) may be provided, which may likewise be present as a plurality of storage sites. One the one hand, a stationary storage site (19) is shown in FIG. 3, which is arranged, e.g., on the wall of a shop (39). On the other hand, a nonstationary storage site (19) may be arranged at the handling units (8, 9) associated with one another.

The handling units (8, 9) may be moved together relative to the workpiece (4) for conveying purposes and for purposes of feeding. The handling units (8, 9) are arranged as floor-mounted handling units in the exemplary embodiments shown and move with their respective conveying means (27). As an alternative, they may also be arranged in another way, e.g., suspended. The handling units (8, 9) may have a height adapted to the workpiece (4), so that they can also move, e.g., under the wings (6). On the other hand, they can also reach the top side and underside as well as the lateral surfaces of the workpiece (4), especially of the fuselage (5) and of the wings (6) in the manner described for carrying out the process.

The detection device (7) is also shown schematically in FIG. 3. It is used to detect process specifications. This may be, on the one hand, the position in space and alignment of the support (16) and/or of the processing tool (3). This is detected by the detection device (7) and is optionally corrected on the basis of the results of the detection. The detection device (7) may be connected for this to the handling device or handling devices (2) or the handling units (8, 9) thereof for control.

The detection device (7) preferably operates in a contactless manner and optically. It contains, on the one hand, an external measuring device (37), which is configured, e.g., as a measuring camera and which is arranged on the roof or at another suitable location in the shop (39). One or more suitable reference marks (38) may be arranged on a support (16) or a supporting beam (17) and/or a processing tool (3). These are indicated in FIGS. 1 through 9. The measuring device (37) may be configured, e.g., as a laser tracker, in which case the reference marks (38) are configured as 6D probes with spherical elements and corresponding placement.

The handling units (8, 9) feed the jointly guided support (16) at the intended process site at the workpiece (4) and position it in the process such that the processing tool (3) reaches the intended process areas, e.g., the surface of the workpiece, in the predefined manner during its motion along the support (16) or supporting beam (17) and can carry out the process there. If the workpiece surface has a contour deviating from the flat shape, e.g., a convex or concave arch, adjustment of the support (16) or supporting beam (17) is optionally needed depending on the instantaneous position of the processing tool (3). This adjustment can be carried out by said coordinated movement of the handling units (8, 9). These can, e.g., raise or lower the support (16) or supporting beam (17) and also change the slope thereof. As a result, the processing tool (3) can be brought at its current position at the support into the necessary association in space with the process site, especially the workpiece surface currently being acted on.

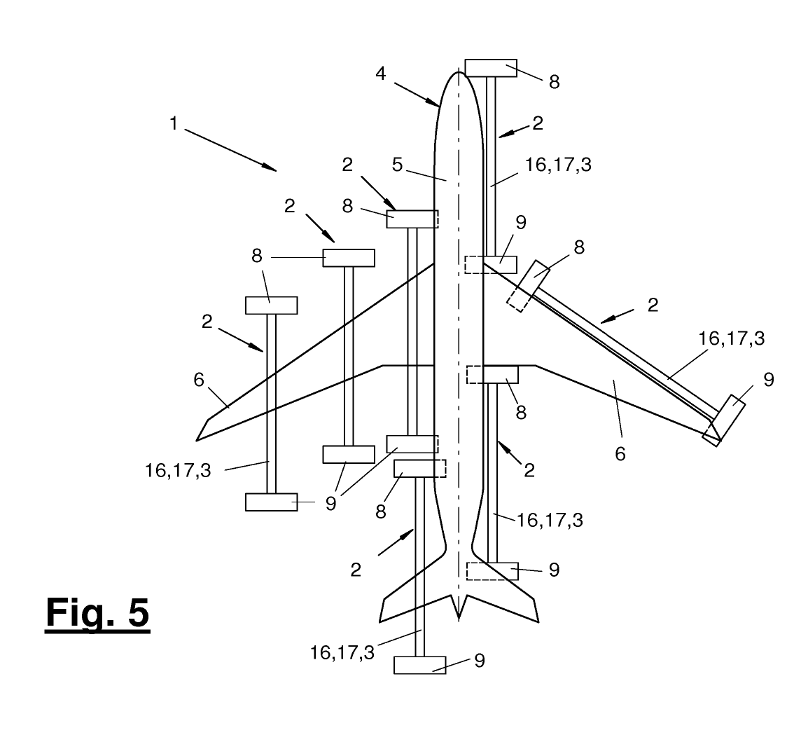

As is illustrated in FIG. 5, a processing device (1) may have a plurality of, e.g., two handling devices (2) of the type mentioned, which independently carry out the process or processes on the left and right sides of the workpiece or aircraft. The handling units (8, 9) can move to different areas of the workpiece and be fed there in a suitable manner with their support (16). FIG. 5 illustrates a plurality of possibilities at different areas of an aircraft.

The handling units (8, 9) position their support (16) at the workpiece (4) and at the process site together. The position and alignment of the support (16) and/or processing tool (3) are detected by means of the detection device (7) in the starting position and during the process and the movement of the processing tool (3) and corrected as needed. This may happen online, in which case there is a correspondingly suitable wireless or wired data connection between the detection device (7) and the control(s) of the handling units (8, 9).

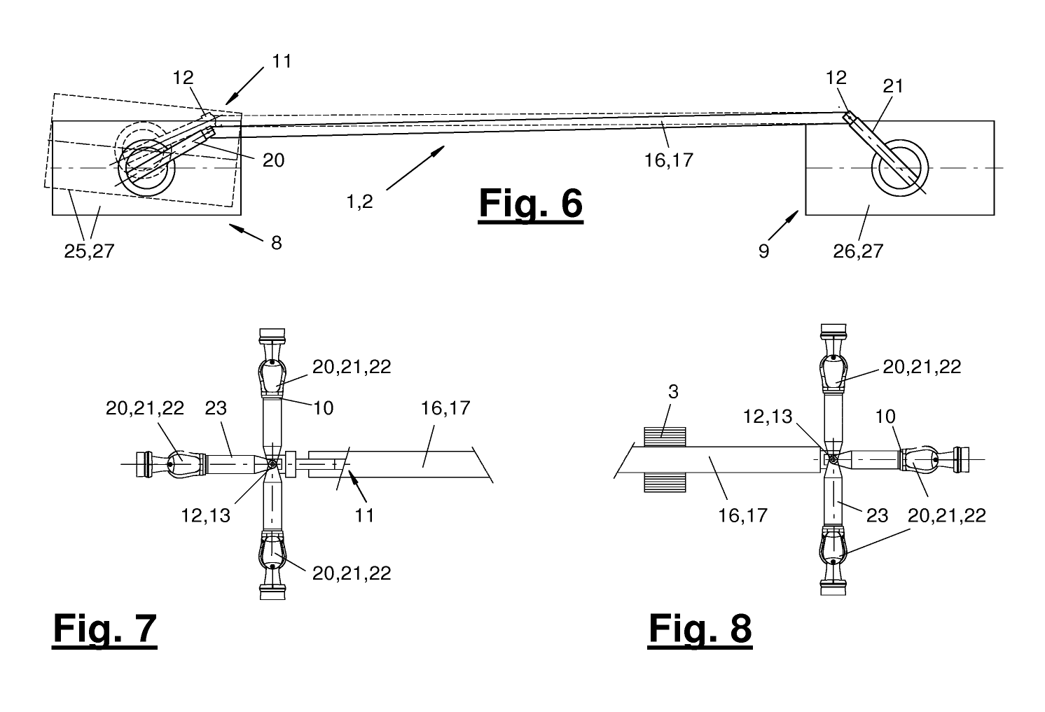

FIGS. 6 through 8 schematically illustrate a handling device (2) with two handling units (8, 9) and with a jointly held and guided support (16). The handling units (8, 9) can move in said manner for conveying and feeding purposes on the foundation and move in a predefined direction. The deviations in the position and alignment of the handling units (8, 9), which are indicated here by broken lines and are exaggerated for clarity's sake, may occur now. To avoid constraints in the connection between the industrial robots (20, 21) and the support (16), a compensating device (11) may be present. This is configured in the variant shown in FIG. 7, e.g., as a connection (12) and offers at least one translatory and at least one rotatory degree of freedom. The connection (12) may be mounted for this, for example, axially displaceably and rotatably at the end of the support.

The connection (12) may establish, furthermore, a connection between the support (16) and the driven link (22) or an extension arm (23), which connection is movable for feeding and process purposes. This connection may be created, e.g., by a universal joint (13), which can optionally be blocked in the desired position. This may be brought about, e.g., by means of a controllable fixing mechanism (14), e.g., a peg.

FIG. 9 shows a variant of the compensating device (11), which has a blockable ball-and-socket joint between the driven element (22) and the processing tool (3) or an interconnected extension arm (23).

FIG. 10 shows a corresponding compensating device (11) for arrangement at a storage site (19) carried along by the handling device (8, 9) for a support (16). Such a storage site (19) is arranged, e.g., at the support frame (28). The industrial robots (20, 21) of the handling units (8, 9) can deposit the support (16) at the storage site (19) during the joint and synchronous travel and pick it up again at the site of use and position and align it together with the processing tool (3) thereof.

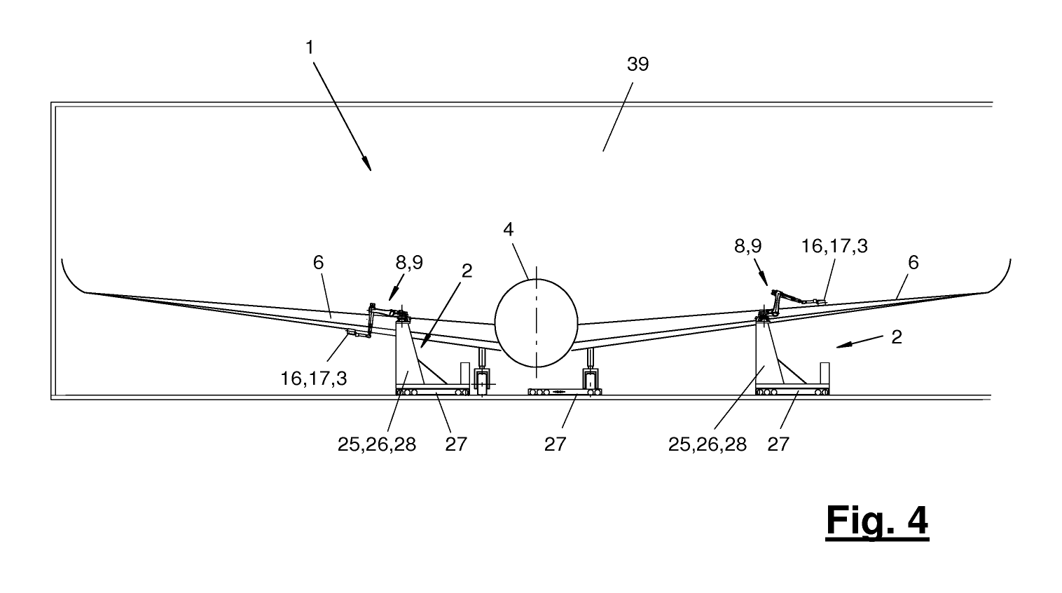

FIG. 4 illustrates, in addition, the case in which two or more handling devices (2) share conveying means (27) that can be uncoupled. For example, the right-hand handling device (2) with its handling units (8, 9) and the conveying means (27) thereof can be brought here at the workpiece (4) into a position favorable for the process and fixed, e.g., by lowering the feet of the support frame (28). The conveying means (27) can then uncouple from the support frames (28) and move to the other side under the aircraft (4) thanks to their low construction and couple there to the other handling device (2) and the support frames (28) thereof. The conveying means (27) can perform, e.g., a lifting motion for coupling and uncoupling. They may optionally also raise and lower a support frame (28) between a raised travel position and a lowered supported or fixed position. After conveying or feeding of the second handling device (2), the conveying means (27) may remain there or uncouple again and return to the first handling device (1) or perform other tasks.

The industrial robots (20, 21) have a working range of preferably several m and can bring their jointly held support (16) with the processing tool (3) into a plurality of predefined, different positions, as a result of which it is possible, e.g., to apply media in a plurality of paths or strips next to each other and over a larger surface of the workpiece. The travel motion of the processing tool (3) at the support (16) or supporting beam (17) is the feed motion proper in the process. If the working range is not sufficient, the industrial robots (20, 21) can move with the conveying means (27) and be displaced into another position. After completion of a process, they can, in addition, be moved to another site of use at the workpiece (4) according to FIG. 5.

In a modified mode of operation, the handling units (8, 9) can move, e.g., the industrial robots (20, 21) and/or the movable supporting devices (25, 26), the support (16), e.g., at right angles or obliquely to the longitudinal extension thereof and carry out a feed motion for the process as a result. The processing tool (3) may be fixed now relatively stationarily at the support (16). Superimposed and coordinated feed motions of the support (16) and processing tool (3) are possible in another variant.

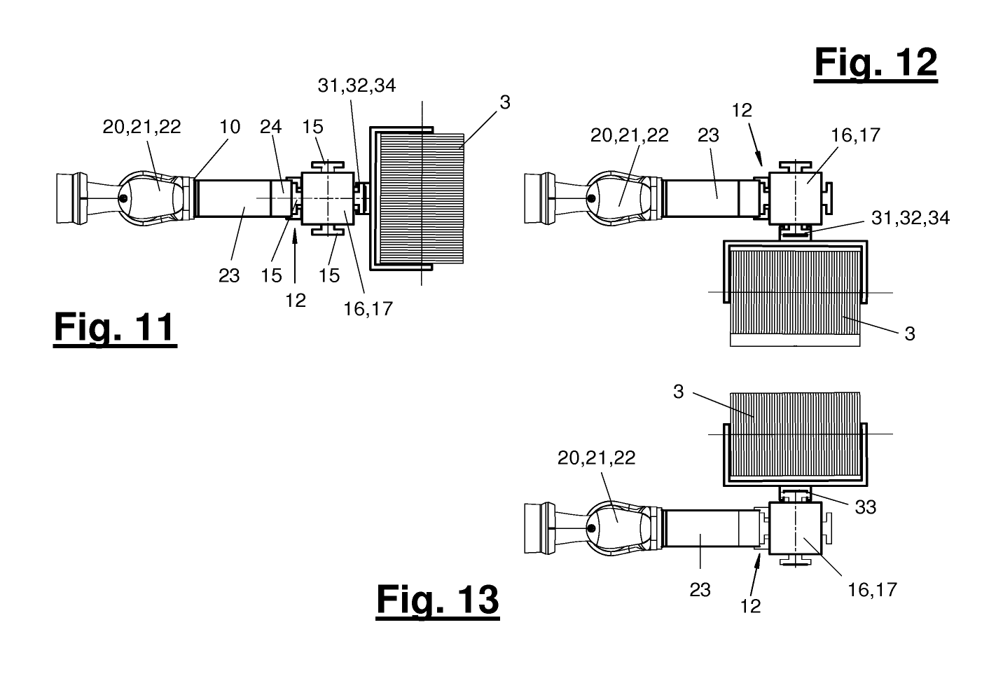

FIGS. 11 through 14 illustrate different possibilities of arranging and aligning a support (16) and a processing tool (3) by means of an industrial robot (20, 21). The drawings illustrate, in addition, a different configuration of a connection (12) between the driven link (22) and the support (16).

In the embodiment according to FIGS. 11 through 13, a support (16), here, e.g., a supporting beam (17) again, may have different connection possibilities on its circumference. They are preferably arranged at the end areas of the support (16) or supporting beam (17). A connection (12) has, e.g., a gripping module (15) at the support (16) and a controllable gripper (24) at the driven link (22) or at an optionally interconnected extension arm (23). The gripper (24) and the gripping modules (15) are positive-locking and are coordinated with one another for clearance-free connection. The gripper (24) or the extension arm (23) may, in turn, be detachably connected to the industrial robot (20, 21) as needed via a coupling (10).

A single gripping module (15) or, as an alternative, a plurality of gripping modules (15) may be arranged on the support (16) on different circumferential or outer sides. The support (16) or supporting beam (17), which may have, e.g., a prismatic, especially rectangular cross section, can pick up as a result with the gripper in different rotation positions. The processing tool (3) can be directed as a result in relation to the industrial robot (20, 21) in a flush position with the driven arm of said industrial robot to the outside or downward or upward according to FIGS. 11 through 13.

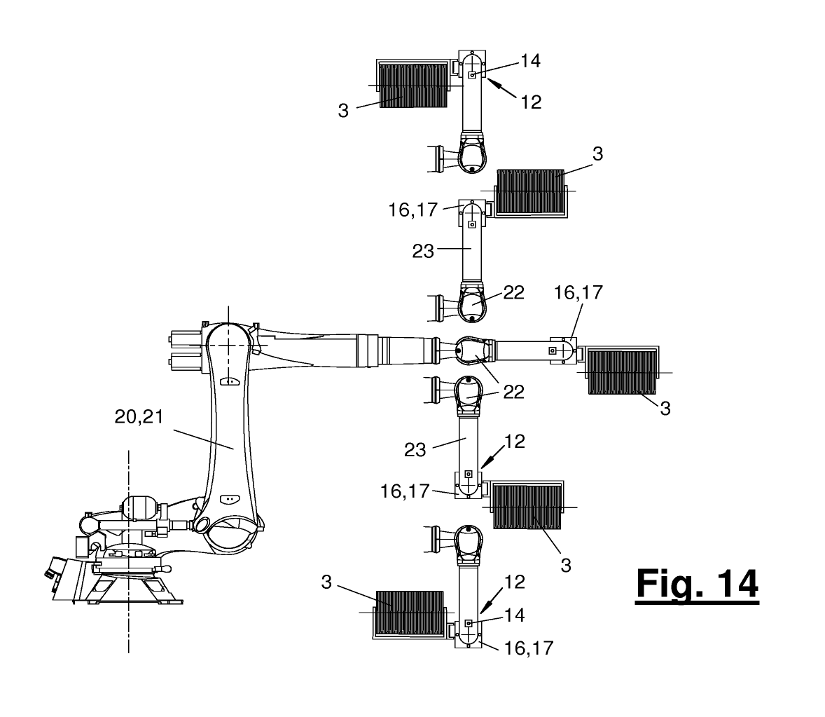

FIG. 14 illustrates the other variant of the connection (12) according to FIGS. 6 through 8. The support (16), gripped on the front side with the connection (12), can likewise be picked up here in different rotation positions, and the rotation position is secured with the controllable fixing mechanism (14), especially the peg. In addition, the driven link (22), which is, e.g., part of a multiaxial robot hand, can be pivoted relative to the industrial robot (20, 21), especially in relation to the last robot hand thereof, about a transverse hand axis by, e.g., 90° upward or downward, so that the positioning possibilities shown in FIG. 14 will be obtained for the support (16) and the processing tool (3) arranged on a side of the support.

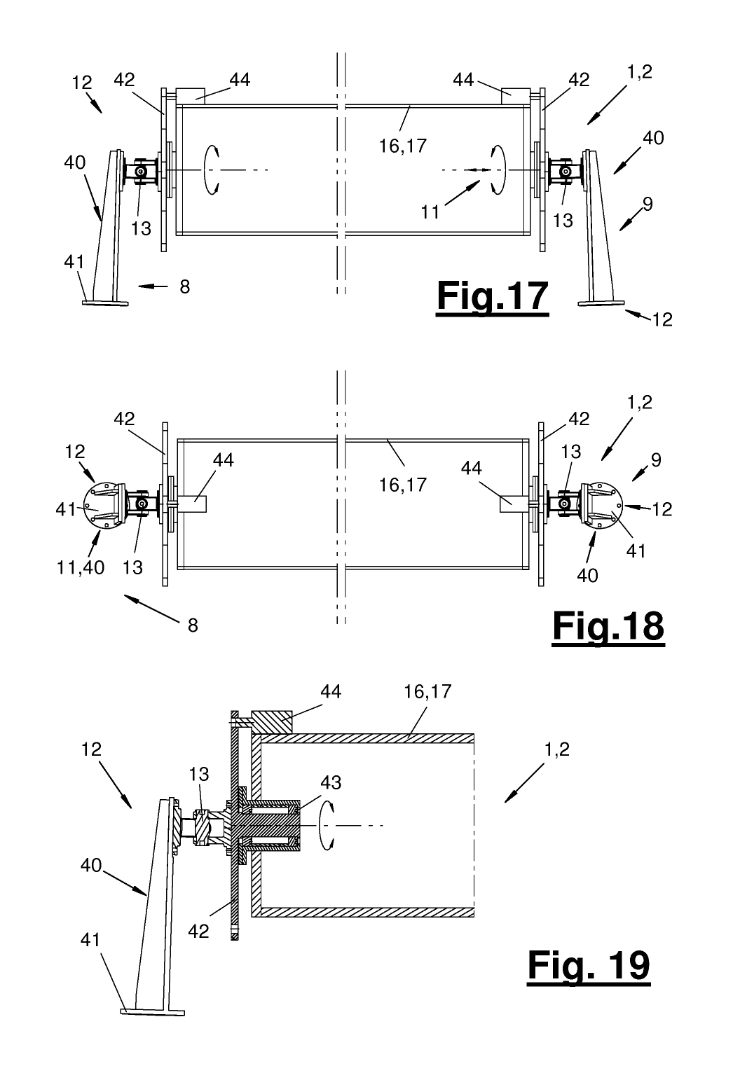

FIGS. 17 through 19 show another variant of the connection (12) and of the compensating device (11). The connection (12) has a supporting spider (42), which is rotatably connected to the support (16), e.g., a supporting beam (17), by means of a bearing (43). A controllable locking mechanism (44), which preferably becomes locked with the free end of an arm of the supporting spider in a positive-locking manner and fixes the rotation position between the multi-armed, especially four-armed supporting spider (42) and the support (16), is arranged on the support (16).

The supporting spider (42) is connected via a universal joint (13) to a bracket (40), which can be connected by a connection means (41), e.g., a flange, to a handling unit (8, 9), especially an industrial robot (20, 21). As an alternative, the bracket (40) may be eliminated, in which case the supporting spider (42) can be connected to a handling unit (8, 9) directly or via the intermediary of the universal joint (13) of a handling unit (8, 9).

The connection (12) shown with the supporting spider (42) and with the bearing (43) may be present at both front ends of the support (16) or supporting beam (17). At one end, the bearing may additionally have a translatory degree of freedom to form a compensating device (11) for the constraint-free conveying of the support, in which case, e.g., the pivot bearing (43) is coupled with a sliding bearing (not shown).

It is possible with this connection (12) to rotate the support (16) about its longitudinal axis and to pick it up in different rotation positions at the handling units (8, 9). The support (16) is deposited for this purpose, e.g., on a suitable substrate, and the locking mechanisms (44) can be opened. A relative rotation can subsequently be carried out between the support (16) and the bracket (40) or the handling units (8, 9). Another arm of the supporting spider (42) now moves into the area of the locking device (44) and meshes with same.

Various modifications of the embodiments shown and described are possible. In particular, the features of the different exemplary embodiments described above and of said variants may be combined with one another, especially also transposed, as desired.

While specific embodiments of the invention have been shown and described in detail to illustrate the application of the principles of the invention, it will be understood that the invention may be embodied otherwise without departing from such principles.

1. A handling device for a processing tool, the handling device comprising:
a plurality of cooperating handling units;
a support, wherein the which cooperating handling units together hold the support and guide same with coordinated movements; and
a conveying device, wherein the processing tool is arranged movably at the support and the support has the conveying device for conveying the processing tool.

2. A handling device in accordance with claim 1, wherein the handling units are arranged at spaced locations from one another and hold the support at different points, including at the edge or end areas thereof.

3. A handling device in accordance with claim 1, wherein the support is configured as a supporting beam.

4. A handling device in accordance with claim 3, wherein the supporting beam, is manufactured from a lightweight material comprising carbon fibers.

5. (canceled)

6. A handling device in accordance with claim 1, wherein at least one of the handling units has a coupling for detachable connection to the support.

7. A handling device in accordance with claim 1, wherein the handling units are arranged movably, as traveling handling units.

8. (canceled)

9. A handling device in accordance with claim 1, wherein the handling device has a connection with at least a rotatory and/or translatory degree of freedom for connecting the support and a handling unit.

10. A handling device in accordance with claim 1, wherein at least one of the handling units has a compensating device for the constraint-free conveying of the support.

11-14. (canceled)

15. A handling device in accordance with claim 1, wherein:
the conveying device has a conveying means, movable along the support in a controlled manner, comprising a carriage with a guide;
the conveying device has a controllable drive for the conveying means; and
the conveying means is movable in a controlled manner by the force of gravity and by a slope of the support, which is established by the handling units.

16-17. (canceled)

18. A handling device in accordance with claim 1, wherein:
the conveying means has a connection comprising a change coupling, for the processing tool; and
the conveying means has an adjusting device with one or more adjusting axes, comprising a rotating device, for the processing tool.

19-20. (canceled)

21. A handling device in accordance with claim 1, wherein at least one of the handling units has a multiaxial, programmable industrial robot.

22-24. (canceled)

25. A handling device in accordance with claim 1, wherein the supporting device has a support frame with a conveying means configured as an omnidirectionally movable, floor-mounted conveying device.

26-30. (canceled)

31. A handling device in accordance with claim 1, wherein the processing tool is configured as a small robot with a processing or handling tool.

32-42. (canceled)

43. A method for handling a processing tool, the method comprising the steps of:
holding and supporting, with a plurality of cooperating handling units together, a support and guiding same with coordinated movements;
arranging the processing tool movably at the support; and
moving the processing too by means of a conveying device.

44. A method in accordance with claim 43, wherein the processing tool is moved by the conveying device with a conveying means, of the conveying device, in a controlled manner along the support by the force of gravity or by a drive.

45. A method in accordance with claim 44, wherein the processing tool is moved by an adjusting device at the conveying means with one or more adjusting axes, wherein the adjusting device comprises a rotating device.

46. (canceled)

47. A method in accordance with claim 43, wherein the handling units convey the support and the processing tool together to a process site comprising a workpiece, and position the support at the workpiece.

48. A method in accordance with claim 43, wherein a fluid medium comprising a paint, is applied by the processing tool to a workpiece or object, embossed and and cured.

49-50. (canceled)

51. A method in accordance with claim 43, wherein the method is intended and configured for the processing, manufacture or retrofitting of workpieces or objects in the non-aerospace area.

52. A method in accordance with claim 43, wherein an inspection, assembly, handling of components, mechanical or other processing of a workpiece surface or of a workpiece, by machining, by grinding, by milling, or assembly or activation or electrical charging of the workpiece surface or of the workpiece is carried out with the processing tool.
